(19) United States
(12) Patent Application Publication
(10) Pub. No.: US 2016/0093254 A1
(43) Pub. Date: Mar. 31, 2016

(54) LUMINANCE CONTROL SYSTEM AND METHOD FOR USE IN DISPLAYS

(71) Applicants: HONG FU JIN PRECISION INDUSTRY (WuHan) CO., LTD., Wuhan (CN); HON HAI PRECISION INDUSTRY CO., LTD., New Taipei (CN)

(72) Inventors: YI-LIANG LI, Wuhan (CN); SHU-QI WU, Wuhan (CN); YU-LIN LIU, Wuhan (CN)

(21) Appl. No.: 14/529,466

(22) Filed: Oct. 31, 2014

(30) Foreign Application Priority Data
Sep. 25, 2014 (CN) 201410494795.6

(51) Int. Cl. G09G 3/34; G09G 3/30

(52) U.S. Cl. CPC G09G 3/3406; G09G 3/30; G09G 2320/062; G09G 2320/0626

(57) ABSTRACT

A luminance control system includes a display with a backlight module, a detecting module, and a control module with a control circuit. The control module is coupled between the backlight module and the detecting module. The detecting module is configured to detect ambient light outside the display and to transmit a detecting signal to the control circuit. A control signal is transmitted from the control circuit to the backlight module according to the detecting signal. The backlight module is configured to automatically adjust illumination according to the control signal to control luminance of the display. The present disclosure further discloses a display luminance control method.

### FIELD

The present disclosure relates to a control system and a method for the control system, and particularly to a luminance control system and a luminance control method for use in a display.

### BACKGROUND

Luminance of displays, used in electronic devices such as notebook computers and all-in-one computers, depend on illumination of backlight modules attached to the displays. An adjustment of the illumination of the backlight module results in an adjustment of luminance of the displays.

### BRIEF DESCRIPTION OF THE DRAWINGS

Implementations of the present technology will now be described, by way of example only, with reference to the attached figures.

FIG. 1 is a block diagram of a luminance control system in accordance with an embodiment.

FIG. 2 is a diagrammatic view of the luminance control system in accordance with an embodiment.

FIG. 3 is a diagrammatic view of a control circuit of FIG. 1.

FIG. 4 is a block diagram of a luminance control method in accordance with an embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to a luminance control system. The luminance control system includes a display with a backlight module, a detecting module, and a control module with a control circuit. The control module is coupled between the backlight module and the detecting module. The detecting module is configured to detect ambient light outside the display and to transmit a detecting signal to the control circuit. The control circuit is configured to transmit a control signal to the backlight module according to the detecting signal. The backlight module is configured to automatically adjust illumination according to the control signal to control luminance of the display.

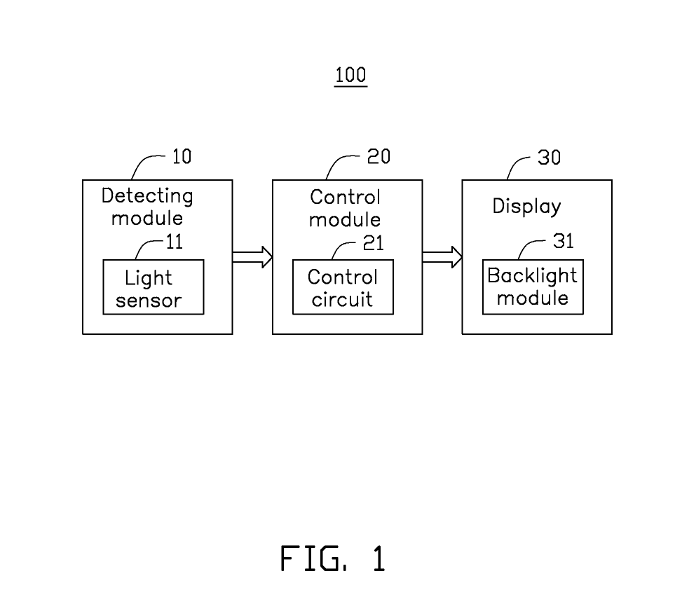

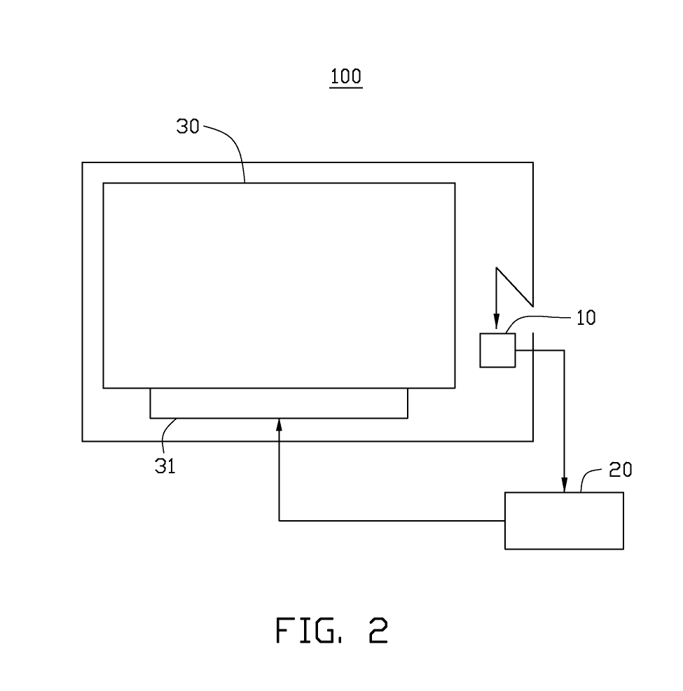

FIGS. 1-2 illustrate that a luminance control system 100 includes a display 30 with a backlight module 31, a detecting module 10, and a control module 20 with a control circuit 21. The control module 20 is coupled between the backlight module 31 and the detecting module 10. In at least one embodiment, the display is used for an electronic device such as a notebook computer or an all-in-one computer.

The detecting module 10 is configured to detect ambient light outside the display 30. The detecting module 10 is coupled to the control module 20 to transmit a detecting signal to the control circuit 21. In at least one embodiment, the detecting module 10 includes a light sensor 11, and the detecting signal is generated by the light sensor 11. In another embodiment, the detecting signal is transmitted to the control module 20 via the inter-integrated circuit (I²C) bus.

The control module 20 is coupled to the backlight module 31 and transmits a control signal to the backlight module 31. The control signal is changed by the control circuit 21 according to the detecting signal. The illumination of the backlight module 31 is automatically adjusted by the backlight module 31 according to the control signal. Thereby the luminance of the display 30 is controlled. In at least one embodiment, the control signal is a Pulse Width Modulation (PWM) signal.

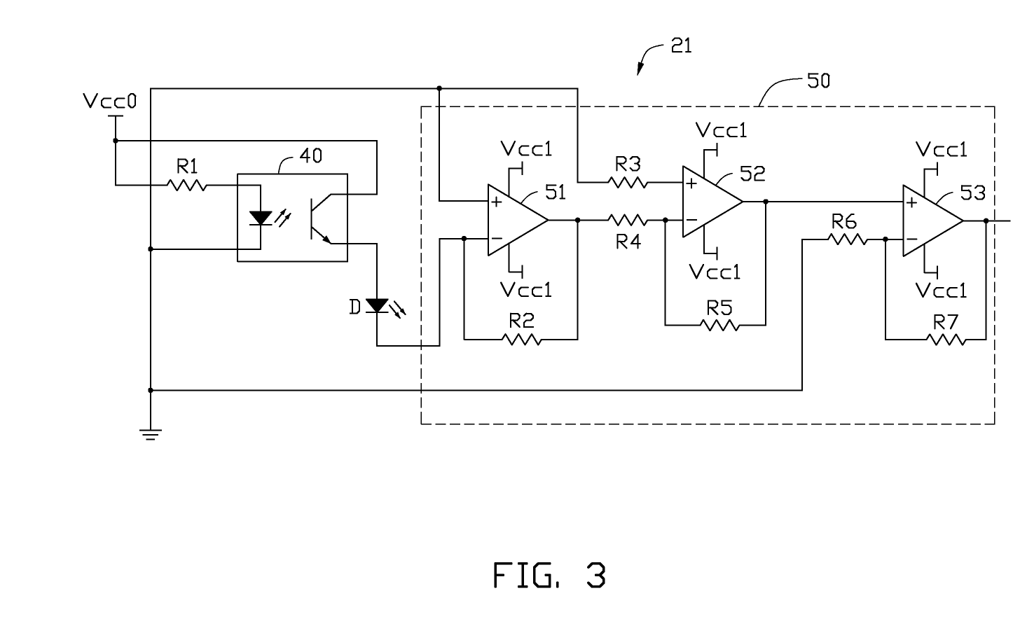

FIG. 3 illustrates that the control circuit 21 includes a main power Vcc0, a coupling module 40, and a comparator circuit 50. The main power Vcc0 is coupled to the comparator circuit 50 via the coupling module 40. The coupling module 40 is configured to receive the detecting signal. A voltage input to the comparator circuit 50 is adjusted by the coupling module 40 according to the detecting signal. The comparator circuit 50 is coupled to the backlight module 31 and is configured to output the control signal. In at least one embodiment, the coupling module 40 includes an optical coupler configured to receive the detecting signal.

In at least one embodiment, the main power Vcc0 is coupled to the coupling module 40 according to a first resistor R1.

In at least one embodiment, the coupling module 40 is coupled to the comparator circuit 50 via a diode D. A positive pole of the diode D is connected to the coupling module 40, and a negative pole of the diode D is connected to the comparator circuit 50. In another embodiment, the diode D is a Light-Emitting Diode (LED).

The comparator circuit 50 includes a first comparator 51, a second comparator 52, and a third comparator 53. The first comparator 51 is a differential input stage of the comparator circuit 50, the second comparator 52 is a gain stage of the comparator circuit 50, and the third comparator 53 is an output stage of the comparator circuit 50. The first comparator 51 is coupled to the coupling module 40 and is configured to receive the voltage input to the comparator circuit 50. The second comparator 52 is coupled between the first comparator 51 and the third comparator 53. The third comparator 53 is coupled to the backlight module 31 and is configured to output the control signal.

A negative power terminal of the first comparator 51 is coupled to the coupling module 40, and a positive power terminal of the first comparator 51 is grounded. A voltage input to the first comparator 51 is adjusted by the coupling module 40 according to the detecting signal. An output terminal of the first comparator 51 is coupled to the negative power terminal of the first comparator 51 via a second resistor R2. The voltage input to the negative power terminal is compared with the voltage input to the positive power terminal by the first comparator 51. A first signal is output by the first comparator 51.

A positive power terminal of the second comparator 52 is grounded via a third resistor R3, and a negative power terminal of the second comparator 52 is coupled to the output terminal of the first comparator 51 via a fourth resistor R4. An output terminal of the second comparator 52 is coupled to the negative power terminal of the second comparator 52 via a fifth resistor R5. The voltage input to the negative power terminal is compared with the voltage input to the positive power terminal by the second comparator 52. A second signal is output by the second comparator 52.

A positive power terminal of the third comparator 53 is coupled to the output terminal of the second comparator 52, and a negative power terminal of the third comparator 53 is grounded via a sixth resistor R6. An output terminal of the third comparator 53 is coupled to the negative power terminal of the third comparator 53 via a seventh resistor R7. The voltage input to the negative power terminal is compared with the voltage input to the positive power terminal by the third comparator 53. The control signal is output by the third comparator 53.

An auxiliary power Vcc1 is coupled to the first comparator 51, the second comparator 52, and the third comparator 53.

In at least one embodiment, the voltage value of the main power Vcc0 is substantially 5 volts, the voltage value of the auxiliary power Vcc1 is substantially 9 volts, the resistance value of the first resistor R1 is substantially 100 Ohms (Ω), the resistance value of the second resistor R2 is substantially 1 KΩ, the resistance value of the third resistor R3 is substantially 6.67 KΩ, the resistance value of the fourth resistor R4 is substantially 10 KΩ, the resistance value of the fifth resistor R5 is substantially 20 KΩ, the resistance value of the sixth resistor R6 is substantially 30 KΩ, and the resistance value of the seventh resistor R7 is substantially 20 KΩ.

The backlight module 41 is coupled to the output terminal of the third comparator 53 to receive the control signal.

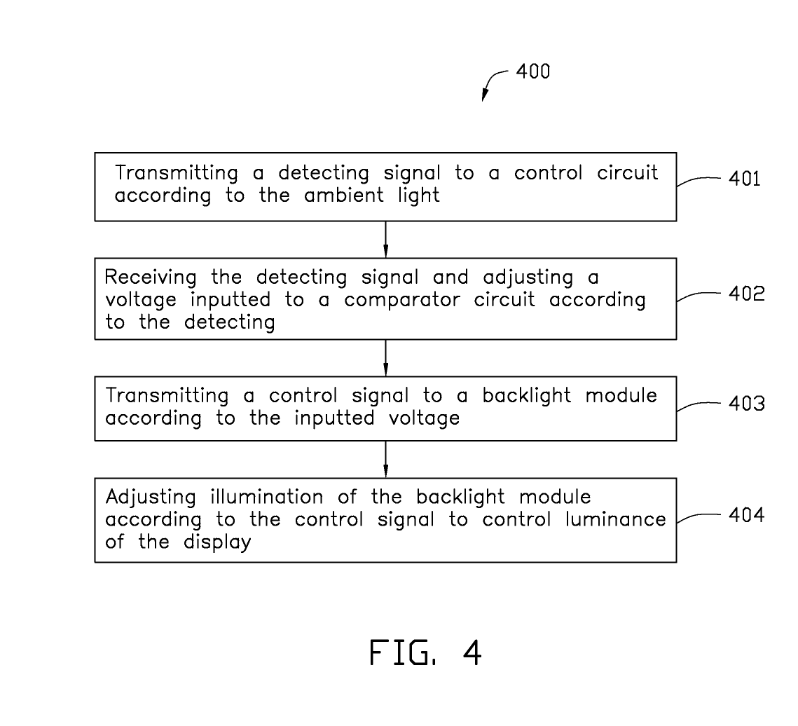

FIG. 4 illustrates a luminance control method 400 for using in the luminance control system 100.

In at least one embodiment, when the ambient light is a first luminance level, the light sensor 11 detects the level of ambient light and generates a first detecting signal. The first detecting signal is transmitted to the control module 20 via the I²C bus (see the block 401 in FIG. 4). The coupling module 40 receives the first detecting signal and adjusts the voltage input to the comparator circuit 50 as a first voltage values according to the first detecting signal (see the block 402 in FIG. 4). A first control signal is transmitted from the comparator circuit 50 to the backlight module 31 according to the first voltage values (see the block 403 in FIG. 4). The illumination of the backlight module 31 is adjusted as a first display luminance by the backlight module 31 itself according to the first control signal, thereby the luminance of the display 30 is controlled by the backlight module 31 (see the block 404 in FIG. 4).

When the ambient light is a second luminance level, the light sensor 11 detects the level of ambient light and generates a second detecting signal. The second detecting signal is transmitted to the control module 20 via the I²C bus and received by the coupling module 40. The voltage input to the comparator circuit 50 is adjusted as a second voltage value by the coupling module 40 according to the second detecting signal. A second control signal is transmitted from the comparator circuit 50 to the backlight module 31 according to the second voltage values. The illumination of the backlight module 31 is adjusted as a second display luminance according to the second control signal; thereby the luminance of the display 30 is controlled by the backlight module 31.

In another embodiment, when the level of ambient light is less than a set value, the light sensor 11 detects the level of ambient light and generates a standard detecting signal. The standard detecting signal is transmitted to the control module 20. A standard control signal is transmitted from the control module 20 to the backlight module 31 according to the standard detecting signal. The illumination of the backlight module 31 is adjusted as a standard display luminance according to the standard control signal; thereby the luminance of the display 30 is controlled by the backlight module 31. When the level of ambient light is not less than the set value, the light sensor 11 detects the level of ambient light and generates a set detecting signal. The set detecting signal is transmitted to the control module 20. A set control signal is transmitted from the control module 20 to the backlight module 31 according to the set detecting signal. The illumination of the backlight module 31 is adjusted as a set display luminance according to the set control signal; thereby the luminance of the display 30 is controlled by the backlight module 31.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A luminance control system comprising:
a display comprising a backlight module;
a detecting module for detecting ambient light outside the display; and
a control module comprising a control circuit, coupled to the backlight module and the detecting module;
wherein the detecting module is configured to transmit a detecting signal to the control circuit, the control circuit is configured to transmit a control signal to the backlight module according to the detecting signal, and the backlight module is configured to adjust illumination of the backlight module according to the control signal, thereby the luminance of the display is controlled by the backlight module.

2. The luminance control system of claim 1, wherein the control circuit comprises a coupling module and a comparator circuit coupled to the coupling module, and a voltage input to the comparator circuit is adjusted by the coupling module according to the detecting signal.

3. The luminance control system of claim 2, wherein the couple module comprises an optical coupler for receiving the detecting signal.

4. The luminance control system of claim 2, wherein the coupling module is coupled to the comparator circuit via a diode.

5. The luminance control system of claim 2, wherein the comparator circuit is coupled to the backlight module and is configured to output the control signal.

6. The luminance control system of claim 2, wherein the comparator circuit comprises a first comparator, the first comparator is coupled to the coupling module and is configured to receive the voltage input to the comparator circuit.

7. The luminance control system of claim 6, wherein a negative power terminal of the first comparator is coupled to the coupling module, and a positive power terminal of the first comparator is grounded.

8. The luminance control system of claim 6, wherein the comparator circuit further comprises a second comparator and a third comparator; the second comparator is coupled between the first comparator and the third comparator, and the third comparator is coupled to the backlight module.

9. The luminance control system of claim 8, wherein a negative power terminal of the second comparator is coupled to the first comparator, and a positive power terminal of the third comparator is coupled to the second comparator.

10. The luminance control system of claim 1, wherein the detecting module comprises a light sensor, the detecting signal generated by the light sensor is transmitted to the control circuit via the inter-integrated circuit bus.

11. A luminance control circuit comprising:
a comparator circuit; and
a coupling module configured to output a control signal to a display;
wherein the coupling module is coupled to the comparator circuit, and a voltage input to the comparator circuit is adjusted by the coupling module.

12. The luminance control circuit of claim 11, wherein the coupling module comprises an optical coupler, and the optical coupler is configured to receive a detecting signal generated by a light sensor.

13. The luminance control circuit of claim 11, wherein the coupling module is coupled to the comparator circuit via a diode.

14. The luminance control circuit of claim 13, wherein a positive pole of the diode is coupled to the coupling module, and a negative pole of the diode is coupled to the comparator circuit.

15. The luminance control circuit of claim 11, wherein the comparator circuit comprises a first comparator coupled to the coupling module.

16. The luminance control circuit of claim 15, wherein a negative power terminal of the first comparator is coupled to the coupling module, and a positive power terminal of the first comparator is grounded.

17. The luminance control circuit of claim 15, wherein the comparator circuit further comprises a second comparator and a third comparator; the second comparator is coupled between the first comparator and the third comparator, and the third comparator is configured to output the control signal.

18. The luminance control circuit of claim 17, wherein a negative power terminal of the second comparator is coupled to the first comparator, and a positive power terminal of the third comparator is coupled to the second comparator.

19. The luminance control circuit of claim 17, wherein a positive power terminal of the second comparator and a negative power terminal of the third comparator are grounded.

20. A display luminance control method comprising:
detecting ambient light and transmitting a detecting signal to a control module;
transmitting a control signal to a backlight module of a display according to the detecting signal; and
adjusting illumination of the backlight module according to the control signal and controlling luminance of the display.
